(19) United States
(12) Patent Application Publication
(10) Pub. No.: US 2013/0261827 A1
(43) Pub. Date: Oct. 3, 2013

(54) CONTROL SYSTEM

(71) Applicants: Rolf Apel, Nuernberg (DE); Manfred Jung, Joehlingen (DE)

(72) Inventors: Rolf Apel, Nuernberg (DE); Manfred Jung, Joehlingen (DE)

(73) Assignee: SIEMENS AKTIENGESELLSCHAFT, MUENCHEN (DE)

(21) Appl. No.: 13/992,424

(22) PCT Filed: Dec. 7, 2010
(86) PCT No.: PCT/EP10/69069

§ 371 Date: Jun. 7, 2013

(51) Int. Cl. G06F 1/26

(52) U.S. Cl. CPC G06F 1/26
USPC 700/291

(57) ABSTRACT

A central device for a control system which controls an energy transfer system that has energy generators and energy consumers. The central device is suitable for determining, by an actual and/or a prognosticated energy consumption, how much energy should be generated by the energy generators. An individual energy bandwidth is assigned to at least one subgroup of the energy consumers connected to the energy transfer system, the bandwidth indicating to what extent the total energy consumption of the subgroup is expected to be able to be raised and/or lowered. The central device is suitable—in view of the energy generating behavior of the energy generators and the individual energy bandwidth of the subgroup—for determining an optimum target energy consumption which lies within the individual energy bandwidth and which the subgroup should achieve in total. The central device further generates a control signal indicating the target energy consumption.

The invention relates to a central device for a control system for controlling a power transmission system having power generators and power consumers, with the central device being suitable for determining, by means of an actual and/or a forecast power consumption, how much power should be generated by the power generators.

As is known, power generators (for example power plants) can be controlled by means of central control devices of the type described, so that said power generators generate appropriate power to meet the respective demand of the load.

It is also known during the simulation of power transmission systems to include large-scale consumers when determining the optimum power flow and power plant control. This enables, among other things, for example, individual large-scale consumers to be switched off or their consumption reduced if the simulation of the power transmission system reveals that the power generator is unable to produce sufficient current or even that an increase in power production would be detrimental.

However, simulation of power transmission systems and active load control of the consumers requires that the central device knows at least more or less exactly the extent to which the individual power consumers can be controlled. That is to say, only when the respective power consumer is also able to reproduce the load characteristic that is specified or forms the basis for the simulation, can the simulation result correctly represent reality and enable efficient control of the power transmission system. In the case of control systems to which a plurality of power generators is connected, the complexity and time of the simulation increases considerably with the number of power generators.

The object underlying the invention is therefore to specify a central device for a control system which can also handle power transmission systems having a plurality of power generators and power consumers.

This object is achieved according to the invention by a central device having the features of claim 1. Advantageous embodiments of the inventive central device are cited in the subclaims.

Accordingly, according to the invention, provision is made for an individual power bandwidth to be assigned to at least one subgroup of the power consumers connected to the power transmission system, said bandwidth indicating to what extent the total power consumption of the subgroup is expected to be raised and/or lowered, and the central device is suitable—in view of the power generating characteristic of the power generators and the individual power band width of the subgroup—for determining an optimum desired power consumption which lies within the individual power bandwidth and which the subgroup should achieve in total, and for generating a control signal indicating the desired power consumption.

An important advantage of the inventive central device is that it can process these individual power bandwidths of subgroups of power consumers. The central device therefore no longer has to take into account every individual, controllable, power consumer to be controlled, but rather it is sufficient if it is established via statistical averaging that a specific subgroup of power consumers is able to cause load changes in order to remain within an individually specified power bandwidth.

A further advantage is that by assigning the power consumers to subgroups and taking into account the possibility for individual subgroups to vary their loads, it is possible to include each subgroup as a virtual power plant in the simulation of the power transmission system and treat them as a “power plant” for simulation purposes. Such a virtual power plant produces virtual power if the power consumers of the subgroup reduce their power consumption. Therefore, taking the virtual power plant into consideration enables the subgroups with their respective individual subgroup load-changing capability to be considered using today's usual standard simulation software which does not provide for the generation of a subgroup as such. Such virtual power plants are in fact not themselves able to produce and supply real power but, by varying the load characteristic of the associated power consumers, are able to provide additional current for other branches or other areas of the power supply system. The virtual power plants can at the same time be simulated and optimized in the central device like normal power generators, with their negative or inverse characteristic being taken into account. If, for example it is established in the context of the simulation that overall too much power is being consumed or an increase in consumption is to be expected, then a decision can be made during the simulation to start up normal power generators and produce more power, or to activate inverse power plants in order to vary the load characteristic and reduce the power consumption.

“Negative” power which cancels out the positive power of the positive power plants, can be taken into account in the simulation. An increase in the power generation of the positive power plants can therefore be prevented by increasing the generation of negative power by virtual power plants and balancing the total load.

The power bandwidths are preferably time-dependent variables or “schedules”.

The invention furthermore relates to a control system for controlling a power transmission system having power generators and power consumers. According to the invention, provision is made for the control system to have a central device, as described above.

With regard to the advantages of the inventive control system, reference should be made to the above explanations in connection with the inventive central device since the advantages of the inventive central device essentially correspond to those of the inventive control system.

According to a particularly preferred embodiment of the control system, provision is made for the control system to have at least one intermediate control device which is connected to the central device and to the subgroup, and is suitable for controlling the subgroup of the power consumers connected thereto, so that in total these achieve a power consumption that corresponds to the control signal of the central device.

In view of a simulation and control of particularly complex power transmission systems which have a plurality of power consumers and power generators, it is considered to be advantageous if the control system has a plurality of intermediate control devices, each of which is linked to the central device and to an individual subgroup of power consumers which are connected to the power transmission system, an individual power bandwidth being assigned in each case to each of the subgroups, said bandwidth indicating to what extent the total power consumption of the respective subgroup is expected to be raised and/or lowered, and in each case each of the intermediate control devices is suitable for controlling the subgroup of power consumers connected thereto so that in total these achieve a specified desired power consumption lying within the individual power bandwidth.

In view of the power generation characteristic of the power generators and of the individual power bandwidths of all subgroups, it is also considered to be advantageous if in each case the central device is suitable for determining for each subgroup an optimum desired power consumption which lies within the respective, individual power bandwidth, which the respective subgroup should achieve, and in each case for generating for each intermediate control device an individual, control signal indicating the respective desired power consumption.

According to another advantageous embodiment, provision is made for at least one of the intermediate control devices to form a higher-level intermediate control device which, with a subordinate subgroup of power consumers connected to it and indirectly linked via a subordinate intermediate control device to the subordinate intermediate control device linked to the subordinate subgroup of the power consumers and the subordinate intermediate control device being suitable for controlling the power consumers of the subordinate subgroup connected to it, so that in total these achieve a power consumption which corresponds to a specified fraction of the desired power consumption assigned to the subgroup.

Furthermore, the invention relates to an intermediate control device for a control system as has been described above.

In this connection, provision is made according to the invention for the intermediate device to be suitable for controlling a subgroup of power consumers connected to it so that in total this subgroup achieves a power consumption that corresponds to a control signal of a higher-level central device and which lies within a power bandwidth individually assigned to the subgroup, said bandwidth indicating to what extent the total power consumption of the subgroup is expected to be raised and/or lowered.

Provision is made in an advantageous development of the intermediate control device for the intermediate control device to have an arithmetic logic unit and a memory in which the consumption characteristic and the adjustability of the power consumers connected to the intermediate control device is stored, and the arithmetic logic unit is programmed so that, taking into consideration the consumption characteristic and adjustability of the power consumers, said arithmetic logic unit determines for each power consumer an individual consumption value, with the proviso that the total of the consumption values corresponds to the control signal of the higher-level central device.

Furthermore, it is considered preferable if the intermediate control device has a communications link to at least one of the power consumers connected to it, and is suitable for negotiating with the power consumer its individual desired power consumption and/or for setting the individual desired power consumption of this power consumer in view of load data which this power consumer supplies, as well as stipulating safety restrictions which are not to be violated.

The invention relates furthermore to a method for controlling a power transmission system having generators and power consumers, and determining by means of an actual and/or a forecast power consumption how much power should be generated by the power generators.

Provision is made according to the invention for an individual power bandwidth to be assigned to at least one subgroup of power consumers connected to the power transmission system, said power bandwidth indicating to what extent the total power consumption of the subgroup is expected to be raised or lowered, and in view of the power generating characteristic of the power generators and the individual power bandwidth of the subgroup, a desired optimum power consumption which lies within the individual power bandwidth and which the subgroup should achieve in total is determined and a control signal indicating the desired power consumption is generated.

Regarding the advantages of the inventive method, reference should be made to the above explanations in connection with the inventive central device, the inventive control system and the inventive intermediate control device, since the advantages of the inventive method correspond to those of the inventive devices.

The invention is explained below with the aid of exemplary embodiments; here by way of example:

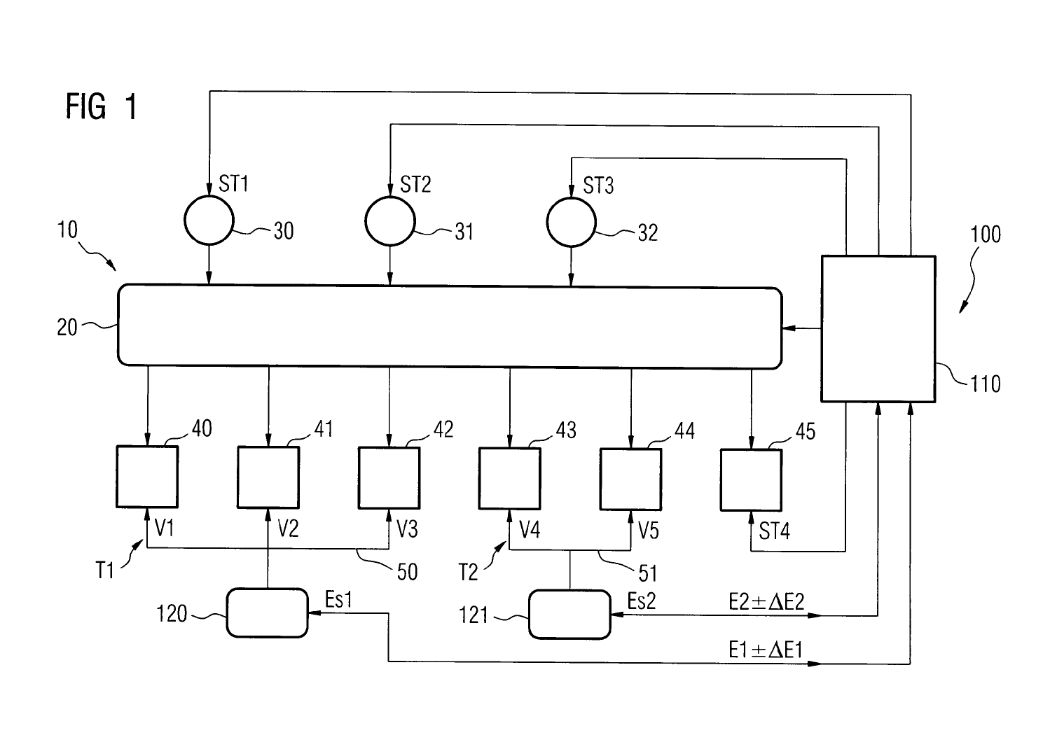

FIG. 1 shows an exemplary embodiment of a control system having a central device and two intermediate control devices which, hierarchically, are arranged in the same level and both directly connected to the central device, and

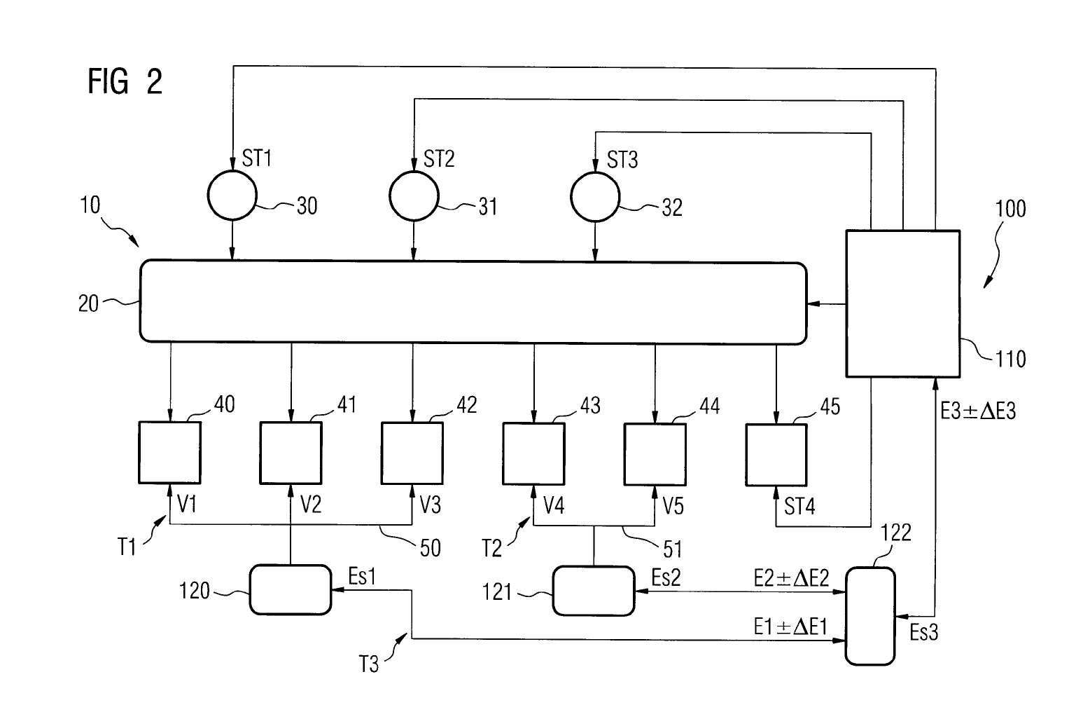

FIG. 2 shows a further exemplary embodiment of an inventive control system with three intermediate control devices, with one of the intermediate control devices being subordinated to another intermediate control device, which forms two hierarchical levels in the intermediate control device level.

For the sake of clarity, the same reference characters in the figures are always used for identical or comparable components.

FIG. 1 shows a power transmission system 10, which includes a power line system 20, power generators 30, 31 and 32, as well as power consumers 40, 41, 42, 44 and 45. The power line system 20 connects the power generators 30 to 32 to the power consumers 40 to 45.

FIG. 1 also shows a control system 100 that is suitable for controlling the power transmission system 10. The control system 10 includes a central device 110, as well as two intermediate control devices 120 and 121.

The central device 110 of the control system 100 is connected to the three power generators 30 to 32 in order to control these with regard to their power generation. Furthermore, the central device 110 is connected to the two intermediate control devices 120 and 121, and to the power consumer 45.

The two intermediate control devices 120 and 121 are in each case connected to a power generator subgroup T1 and T2, respectively. The intermediate control device 120 is thus connected to the three power consumers 40, 41 and 42 via a communications network 50. The intermediate control device 121 is connected via a communications network 51 to the two power consumers 43 and 44, which form a second subgroup T2.

In each case, an individual, preferably time-dependent power bandwidth, denoted in FIG. 1 by references E1±ΔE1 (or E1(t)±ΔE1(t)) and E2±ΔE2 (or E2(t)±ΔE2(t)), is assigned to each of the two subgroups T1 and T2. The individual power bandwidths E1±ΔE1 and E2±ΔE2 are made available to the central device 110 for the simulation of the power transmission system 10. The power bandwidths E1±ΔE1 and E2±ΔE2 can be stored in a memory, not shown in FIG. 1, or are directly fed into the central device 110 from outside. Alternately, the individual power bandwidths E1±ΔE1 and E2±ΔE2 can also be transmitted from the respective intermediate control device 120 or 121 to the central device 110 via appropriate control cables; FIG. 1 shows the latter case by way of example.

The arrangement in FIG. 1 can be described as follows:

The central device 110 simulates and/or optimizes the power transmission system 10 by means of actual and/or forecast power consumption values, as to how much power should be generated by the power generators 30, 31 and 32. This simulation takes account of the power bandwidths ΔE1 and ΔE2, which indicate to what extent the total power consumption of the two subgroups T1 and T2 is expected to be raised and/or lowered in order to match the total consumption of all consumers 40 to 45 to the amount of power which can be generated by the three power consumers 30 to 32.

During the simulation of the power transmission system 10, the central device 110 generates control signals ST1 to ST3 for the power generators 30 to 32, which indicate how much power the power generators should generate. Furthermore, said central device generates for the power consumer 45 a control signal ST4, which directly specifies its consumption.

In contrast to the power consumer 45, the power consumers 40 to 45 are not directly addressed by the central device 110. Instead, the central device 110 generates desired consumption values Es1 and Es2, which it transmits to the two intermediate control devices 120 and 121. Here the desired power consumption value Es1 indicates which desired consumption value the three power consumers 40, 41 and 42 should achieve altogether, that is to say in total. The power consumption value Es2 indicates the total power consumption which the two power consumers 43 and 44 should have. In this case the following applies:

E1−ΔE1≦Es1≦E1+ΔE1

E2−ΔE2≦Es2≦E2+ΔE2

where E1 and E2 each denote a mean power value and ΔE1 and ΔE2 each denote the fluctuation range to be adhered to.

Each of the desired power consumption values Es1 and Es2 therefore lies in the associated power bandwidth E1±ΔE1 or E1±ΔE2.

The intermediate control device 120 evaluates the desired power consumer value Es1 and in each case determines an individual power consumption value (or target power consumption value) V1, V2 and V3 for each of the three power consumers 40, 41 and 42. The three power consumption values V1, V2 and V3 indicate the power consumption to which the respective power consumer 40, 41 and 42 should adjust. The corresponding power consumption values V1 to V3 are transmitted to the three power consumers 40 to 42 via the communications network 50.

In calculating the individual power consumption values V1 to V3, the intermediate control device 120 takes into account the desired power consumption Es1 specified by the central device 110. The individual consumption values are determined so that the total of the consumption values V1 to V3 corresponds to the desired consumption value Es1; the following therefore applies:

V1+V2+V3=Es1.

The intermediate control device 121, to which the two power consumers 43 and 44 are connected, operates in a corresponding manner. Using the desired consumption value Es2, the intermediate control device 121 calculates individual power consumption values V4 and V5 for the two power consumers 43 and 44; where the following applies:

Es2=V4+V5.

The individual power consumption values V4 and V5 are transmitted via the communications network 50 to the two power consumers 43 and 44, which are consequently adjusted so that they comply with the corresponding consumption value.

The two intermediate control devices 120 and 121 can either themselves or automatically determine the individual consumption values by means of specified control algorithms; alternately, provision can be made for the intermediate control devices to communicate with the associated power consumers via the respective communications network 50 or 51, and coordinate with the respective power consumers how much power is currently required and to what extent an increase or reduction in consumption can be implemented at the respective point in time.

The assignment of the power consumers to subgroups T1 and T2 takes into account their statistically expected load characteristic. Preferably in each case the subgroups are populated with power consumers which behave in a similar way and whose load characteristic can be varied to a similar extent. Such an assignment ensures with relatively high statistical probability that the individual power bandwidths individually assigned to the subgroups can actually be adjusted and that the intermediate control devices are actually also able to convert the desired power consumption values which are transmitted by the central device 110.

FIG. 2 shows a second exemplary embodiment of a power transmission system 10 that is controlled by a control system 100.

In contrast to the control system of FIG. 1, in the control system 100 of FIG. 2 a third intermediate control device 122 is provided which hierarchically is of a higher level than the two intermediate control devices 120 and 121. The central device 110 is therefore directly linked only to the higher-level intermediate control device 122; the connection to the two intermediate control devices 120 and 121 is made only indirectly via the higher-level intermediate control device 122.

In the exemplary embodiment of FIG. 2, the subordinate intermediate control devices 120 and 121 transmit their power bandwidths E1±ΔE1 and E2±ΔE2 to the higher-level intermediate control device 122 which, using these data, transmits a power bandwidth E3±AE3 to the central device 110; here the following applies:

E3=E1=E2 and

ΔE3=ΔE1+ΔE2

During the simulation of the power transmission system 10, the central device 110 utilizes only the power bandwidth E3±AE3 which has been transmitted by the higher-level intermediate control device 122, as well as the expected power consumption of the consumer 45 and the power generation characteristic of the three power generators 30 to 32.

During the simulation, a calculation is made as to what power consumption of the consumer 45 and the subgroup T3 of power consumers formed by the two subordinate subgroups T1 and T2 should have, and optimum control signals are determined for the control of the power generators 30, 31 and 32. A corresponding desired power consumption value Es3 for the subgroup T3 is transmitted from the central device 110 to the higher-level intermediate control device 122, which implements further control of the subordinate intermediate control devices 120 and 121 and therefore indirectly the control of consumers 40 to 44. Using the desired power consumption value Es3, the higher-level intermediate control device 122 generates the desired power consumption values Es1 and Es2, which indicate the desired power consumption the two subgroups T1 and T2 should achieve, taking into account that the following must apply:

Es3=Es1+Es2.

The desired power consumption values Es1 and Es2 are conveyed to the two intermediate control devices 120 and 121, which control their respective subgroups T1 and T2, as has already been explained in connection with FIG. 1.

In the arrangement in FIG. 2, the subordinate subgroups T1 and T2 can be considered as a dedicated subgroup T3 which is managed by the higher-order intermediate control device 122. In other words, the consumers 40 to 44, along with the subordinate intermediate control devices 120 and 121, therefore form two separate power consumers which are controlled by the higher-order intermediate control device 122.

The central device and the intermediate control devices preferably have programmable arithmetic logic units which are programmed so that they can execute the described functions. Moreover, in each case the central device and the intermediate control devices preferably include one or a plurality of processors and one or a plurality of memory devices.

### LIST OF REFERENCE SYMBOLS

10 Power transmission system
20 Power line system
30 Power generator
31 Power generator
32 Power generator
40-45 Power consumers
50 Communications network
51 Communications network
100 Control system
110 Central device
120 Intermediate control device
121 Intermediate control device
122 Intermediate control device
V1-V5 Power consumption values (target power consumption values)
Es1 Desired consumption value
Es2 Desired consumption value
Es3 Desired consumption value
ST1 Control signal
ST2 Control signal
ST3 Control signal
ST4 Control signal
T1 Subgroup
T2 Subgroup
T3 Subgroup
E1±ΔE1 Power bandwidth
E2±ΔE2 Power bandwidth
E3±AE3 Power bandwidth

1-10. (canceled)

11. A central device system for a control system for controlling a power transmission system having power generators and power consumers, the central device system determining, by means of at least one of an actual power consumption or a forecast power consumption, how much power should be generated by the power generators, the central device system comprising:
a central device assigning an individual power bandwidth to at least one subgroup of the power consumers connected to the power transmission system, the individual power bandwidth indicating to what extent a total power consumption of the subgroup is expected to be one of raised or lowered; and
said central device, in view of power generating characteristic of the power generators and the individual power bandwidth of the subgroup, determining an optimum desired power consumption lying within the individual power bandwidth, and which the subgroup should achieve in total, said central device further generating a control signal indicating the optimum desired power consumption.

12. A control system for controlling a power transmission system having power generators and power consumers, the control system comprising:
a central device assigning an individual power bandwidth to at least one subgroup of the power consumers connected to the power transmission system, the individual power bandwidth indicating to what extent a total power consumption of the subgroup is expected to be one of raised or lowered; and
said central device, in view of power generating characteristic of the power generators and the individual power bandwidth of the subgroup, determining an optimum desired power consumption lying within the individual power bandwidth, and which the subgroup should achieve in total, and said central device generating a control signal indicating the optimum desired power consumption.

13. The control system according to claim 12, further comprising at least one intermediate control device connected to said central device and to the subgroup, and said intermediate control device controlling the subgroup of the power consumers connected to said intermediate control device, so that the subgroup achieves in total a power consumption which corresponds to the control signal of said central device.

14. The control system according to claim 13, wherein:
said intermediate device is one of a plurality of intermediate control devices, each of said intermediate control devices is linked to said central device and to an individual subgroup of the power consumers which are connected to the power transmission system;
in each case, the individual power bandwidth is assigned to each of the subgroups, the individual power bandwidth indicating to what extent a total power consumption of a respective subgroup is expected to be at least one of raised or lowered; and
in each case, each of said intermediate control devices controlling the subgroup of the power consumers connected to said intermediate control device, so that the subgroup achieves in total a specified desired power consumption which lies within the individual power bandwidth.

15. The control system according to claim 14, wherein in view of the power generating characteristic of the power generators and of the individual power bandwidths of all the subgroups, said central device determines for each of the subgroups the optimum desired power consumption which the respective subgroup should achieve, and which lies within the respective individual power bandwidth, and in each case for generating for each of said intermediate control devices an individual control signal indicating the respective desired power consumption.

16. The control system according to claim 14, wherein:
at least one of said intermediate control devices is a higher-level intermediate control device which is indirectly linked via a subordinate one of said intermediate control devices to a subordinate subgroup of the power consumers connected to said subordinate intermediate control device; and
the subordinate subgroup of the power consumers is linked to said subordinate intermediate control device, and said subordinate intermediate control device controlling the power consumers connected to said subordinate intermediate control device, so that the subordinate subgroup achieves in total a power consumption which corresponds to a specified fraction of the desired power consumption assigned to the subgroup.

17. An intermediate control device system for a control system for controlling a power transmission system having power generators and power consumers, the control system containing a central device assigning an individual power bandwidth to at least one subgroup of the power consumers connected to the power transmission system, the individual power bandwidth indicating to what extent a total power consumption of the subgroup is expected to be one of raised or lowered and the central device, in view of power generating characteristics of the power generators and the individual power bandwidth of the subgroup, determining an optimum desired power consumption lying within the individual power bandwidth, and which the subgroup should achieve in total, the central device generating a control signal indicating the optimum desired power consumption, the intermediate control device system comprising:
an intermediate control device for controlling the subgroup of the power consumers connected to said intermediate control device so that the subgroup achieves in total a power consumption which corresponds to the control signal from the central device and which lies within the individual power bandwidth which is individually assigned to the subgroup, the individual power bandwidth indicating to what extent the total power consumption of the subgroup is expected to be at least one of raised or lowered.

18. The intermediate control device system according to claim 17, wherein said intermediate control device has an arithmetic logic unit and a memory in which a consumption characteristic and an adjustability of the power consumers connected to said intermediate control device are stored, said arithmetic logic unit is programmed so that, in view of the consumption characteristic and the adjustability of the power consumers, said arithmetic logic unit determines for each of the power consumers an individual consumption value, with a proviso that a total of the consumption values corresponds to the control signal of the central device.

19. The intermediate control device system according to claim 18, wherein said intermediate control device is linked in a communications network to at least one of the power consumers connected to it and is suitable for negotiating with the power consumer an individual desired consumption of the power consumer and/or the individual desired power consumption of the power consumer in view of load data which the power consumer supplies, and for stipulating specified safety restrictions.

20. A method for controlling a power transmission system having power generators and power consumers, which comprises the steps of:
determining by means of at least one of an actual power consumption or a forecast power consumption how much power should be generated by the power generators;
assigning an individual power bandwidth to a subgroup of the power consumers connected to the power transmission system, the individual power bandwidth indicating to what extent a total power consumption of the subgroup is expected to be at least one of raised or reduced;
determining, in view of power generating characteristics of the power generators and of the individual power bandwidth of the subgroup, an optimum desired power consumption which lies within the individual power bandwidth, and which the subgroup should achieve in total; and
generating a control signal indicating the optimum desired power consumption.
